(19) United States
(12) Patent Application Publication
(10) Pub. No.: US 2013/0257602 A1
(43) Pub. Date: Oct. 3, 2013

(54) CONTROL AND HAPTIC FORCE-FEEDBACK SYSTEMS

(71) Applicant: PANAVISION, INC., Woodland Hills, CA (US)

(72) Inventor: John M. Higbie, Woodland Hills, CA (US)

(73) Assignee: Panavision, Inc., Woodland Hills, CA (US)

(21) Appl. No.: 13/786,669

(22) Filed: Mar. 6, 2013

Related U.S. Application Data
(60) Provisional application No. 61/616,185, filed on Mar. 27, 2012.

(51) Int. Cl. G08B 6/00

(52) U.S. Cl. CPC G08B 6/00
USPC 340/407.2

(57) ABSTRACT

A control system that simulates forces associated with controls for mechanically-driven heads includes a control element; a haptic force-feedback system, and a sensor system. Haptic elements can include stiffness elements, motors, and brakes. Each of these haptic elements, used alone or in combination, is capable of producing one or more haptic force-feedback effects that simulate forces associated with controls for mechanical heads. Such forces could result, for example, from handwheel accelerations, decelerations, gear cogging, etc.

### BACKGROUND

1. Field of the Invention

The field of the present invention is control and haptic force-feedback systems for motorized heads.

2. Background

Camera operators, particularly those that work in the motion picture industry, primarily use control systems which are directly coupled to gear-driven heads. In some cases, however, depending on the nature of the shot, camera operators are required to use control systems which are not directly coupled to gear-driven heads. For example, remote heads are typically positioned at the end of a crane a significant distance away from control systems.

In many cases, control systems include handwheel assemblies which use electronic controls. Unfortunately, these types of handwheel assemblies do not provide operators with a tactile experience similar to handwheel assemblies directly coupled to gear-driven heads. Many camera operators prefer the tactile experience associated with handwheel assemblies coupled to gear-driven heads. As skilled operators, they have become accustomed to the overall feel and resistive forces associated with these types of handwheel assemblies. In situations when operators are required to use typical remote head control systems, some have difficulty positioning the camera to obtain the expected shot. As a result, more frequent takes are required, which in turn increases production time and cost.

In an attempt to provide camera operators with a tactile experience that simulates the feel of control systems directly coupled to gear-driven heads, some remote head manufacturers have installed components within handwheel assemblies. For example, a small flywheel may be installed within a handwheel assembly to provide some resistive force. Although somewhat useful for its intended purpose, a small flywheel is unable to simulate loads associated with typical camera systems. Other types of components installed in handwheel assemblies are similarly deficient.

Given the limitations of these types of components, there is still a need for improved systems and handwheel assemblies used to control camera positioning. The present invention fulfills this need and provides further related advantages, as described in the following summary.

### SUMMARY

The invention is directed to control and haptic force-feedback systems which simulate forces associated with controls for mechanically-driven heads. In one aspect, a control system includes a control element, a haptic force-feedback system coupled to the control element, a sensor system that monitors motion of the control element and provides a power source for the haptic element, and control circuitry that commands the sensor system. Control elements which may be used in the system include handwheels, joysticks, panbars, levers, knobs and other devices capable of manual manipulation.

The haptic force-feedback system includes at least one haptic element that allows the system to simulate forces a camera operator would experience if they were rotating or translating a camera or other mass coupled to a mechanically-driven head. Haptic elements can include stiffness elements, actuated devices, such as motors and brakes, and various types of devices coupled to fluids having rheological properties that change upon exposure to electric and/or magnetic fields. Each of these haptic elements, used alone or in combination, is capable of producing one or more haptic force-feedback effects that simulate forces associated with controls for mechanically-driven heads. Such forces could result, for example, from handwheel accelerations, decelerations, gear cogging, etc.

### BRIEF DESCRIPTION OF THE DRAWINGS

In the drawings, wherein like reference numerals refer to similar components:

FIG. 1 shows control systems for a remote head mounted on a tripod assembly;

FIG. 2 shows control systems for a remote head mounted on a plate;

FIG. 3 shows a control system that includes a control element, a haptic force-feedback system, and a sensor system each coupled to a shaft;

FIG. 4 illustrates a cross-section of one type of haptic element;

FIG. 5 schematically illustrates the haptic force-feedback system and control circuitry that commands the sensor system;

FIG. 6 illustrates an embodiment of an encoder; and

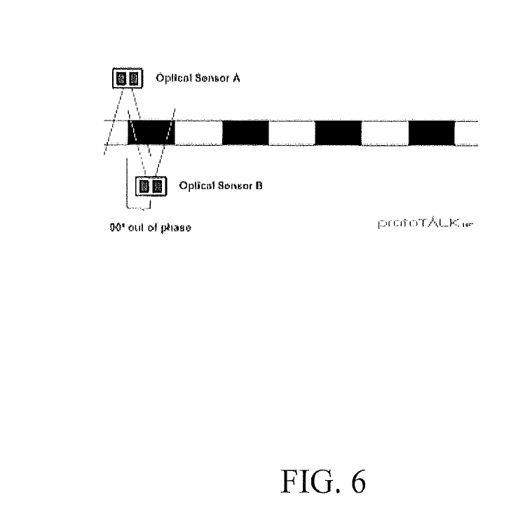

FIG. 7 is a process flow chart, outlining steps implemented by the control circuitry.

### DETAILED DESCRIPTION

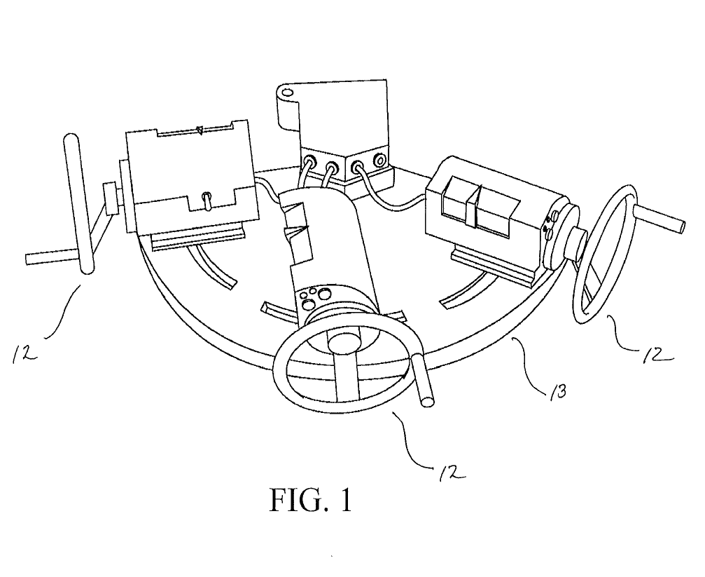

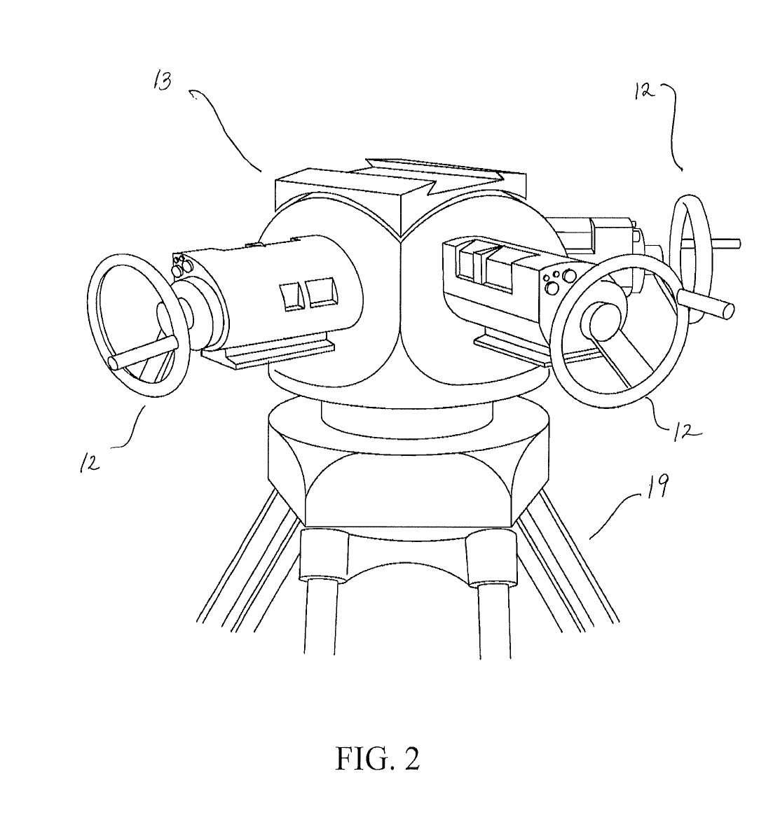

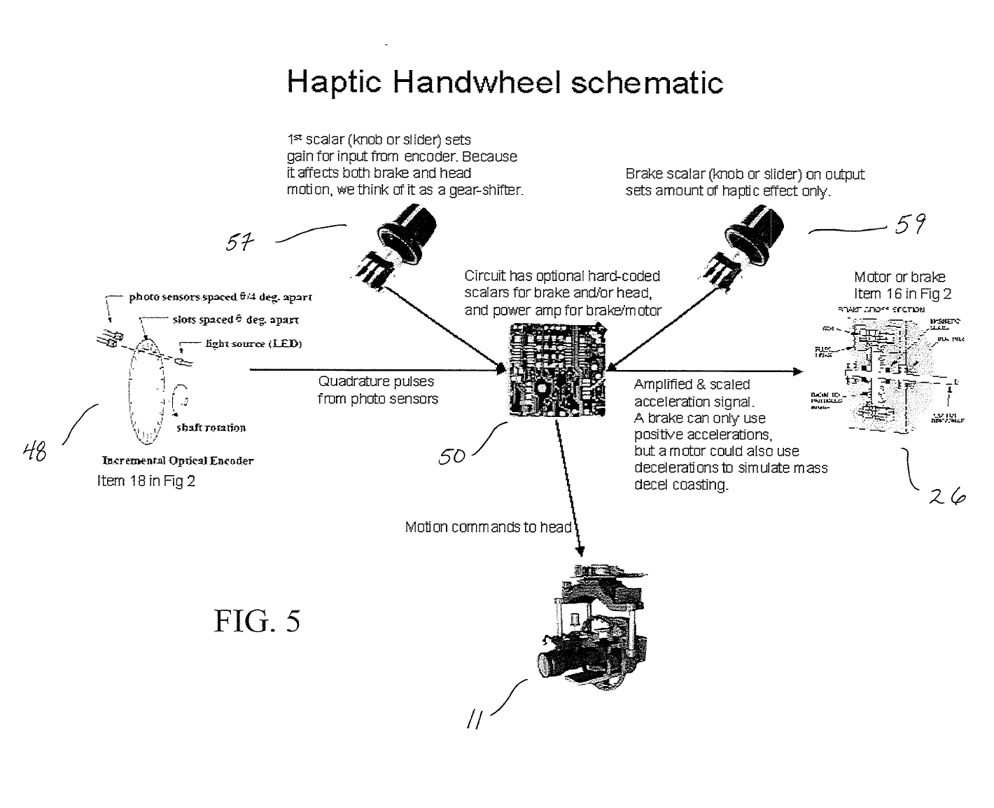

Turning in detail to the drawings, FIGS. 1 and 2 illustrate control systems 10 for a camera 11 (FIG. 5). As shown, the control element 12 for each control system 10 is a handwheel assembly. The system 10 may include one or more control elements 12 disposed on a mount 13, which may be oriented in any direction. FIG. 1 shows the system 10 coupled to a mount 13 having a substantially horizontal orientation, where the mount is coupled to the underside of each control element. The mount may be configured as a mounting plate 15 that is provided with slots 17, which allow for linear adjustment of each handwheel assembly along a predetermined linear profile. FIG. 2 shows the system 10 coupled to a mount 13 having a substantially vertical orientation, where the mount is coupled to an end of each control element. As further shown in FIG. 2, the mount 13 may be coupled to a positioning assembly 19, such as a tripod.

Although handwheel assemblies are shown, each control element may be any other type of input device, including joysticks, panbars, knobs, levers, and the like. Therefore, as used herein, the term “control element” is to be broadly construed as any device capable of manual manipulation, which is used for control and positioning of the camera 15 (FIG. 5), and particularly a video camera. Such control elements include pan/tilt and pan/tilt/roll controls.

Where handwheel assemblies are used, they typically operate in a position encoder mode, where the position of a motorized axis follows the position of the handwheel at a predetermined and adjustable ratio. For example, a mechanical gear head may be adjustable from 20:1 to 80:1. Another type of control element is a panbar, which is a handle that operates both pan and tilt together. Panbars commonly incorporate fluid draft schemes to dampen bumping and jerking movements in an operator's hand motion. In addition to handwheel assemblies and panbars, combinations of different types of control elements may also be used within a single control system.

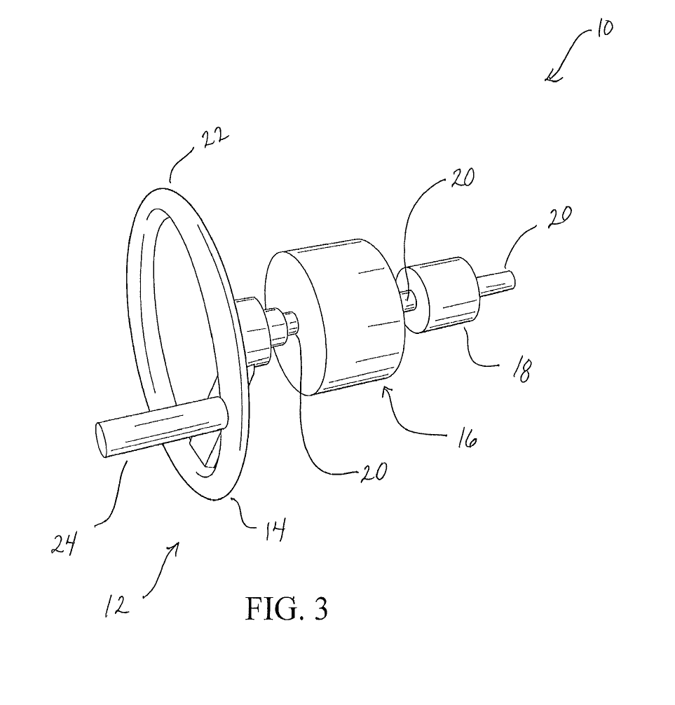

FIG. 3 further illustrates a control system 10, which includes a control element 12 configured as a handwheel assembly. The control system includes the control element 12, a haptic force-feedback system 16, and a sensor system 18 each coupled to a shaft 20. Handwheel assemblies shown in FIGS. 1-3 comprise a wheel 22, having a hub and a one or more spokes, and a handle 24.

The haptic force-feedback system simulates forces associated with controls and control assemblies, such as handwheel assemblies, such as those used in conjunction with mechanically-driven heads. In one aspect, the haptic force-feedback system is configured to simulate inertial effects a camera operator would experience while controlling the positioning of a mass, using directly coupled mechanical control mechanisms. Mechanically-driven heads include fluid heads, belt-driven heads, simple friction heads, and gear-driven heads. The haptic force-feedback system can therefore simulate the tactile experience preferred by camera operators who frequently use control systems directly coupled to gear-driven heads.

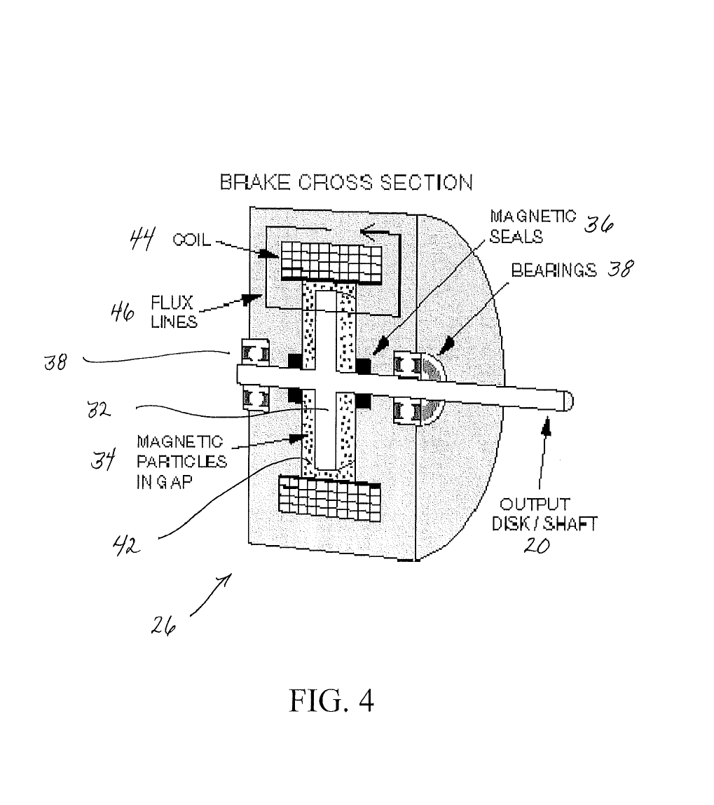

FIG. 4 illustrates one type of haptic element 26 configured as a brake. In this brake configuration, the haptic element 26 comprises a magnetic particle brake 30, having a rotor 32, magnetic particles 34, and magnetic seals 36 disposed within a brake housing 40. The brake 30 may also include bearings 38, having any configuration suitable for support of the brake on the shaft 20.

The rotor 32 is coupled to the shaft 20 and disposed within a gap 42. The brake 30 further includes a plurality of magnetic particles 34 dispersed within the gap 42 and magnetic seals 36, adjacent the gap. The magnetic particles 34 may be contained within a fluid or other substance having alterable viscous properties. Such substances may be Magneto-Rheological (“MR”) substances such as ferrofluids, having rheological properties that change upon exposure to a magnetic field. For example, some MR substances may change from a free-flowing liquid to a semi-solid form upon exposure to a magnetic field.

Use of one or more haptic elements 26, such as the one shown in FIG. 4, allows the haptic force-feedback system to simulate forces a camera operator would experience if they were rotating or translating a camera or other mass coupled to a mechanically-driven head. Such haptic elements can include any element or component that provides a sensory effect that would be experienced by a camera operator using controls directly coupled to a mechanically-driven head. These elements can include stiffness elements, actuated devices, motors and brakes. Several types of motors and brakes may be used, including inductive, brushed, brushless motors and ferrofluid brakes and disc or drum brakes, which are actuated by magnets or piezoelectric devices.

Haptic elements may also include various types of devices coupled to fluids having rheological properties that change upon exposure to electric and/or magnetic fields. Each of these haptic elements, used alone or in combination, is capable of producing one or more haptic force-feedback effects that simulate forces associated with controls for mechanically-driven heads. Such forces could result, for example, from handwheel accelerations, decelerations, gear cogging, etc.

Coils 44 are also disposed within the brake for supply of electric current from a power source (not shown). The supply of electric current facilitates generation of a magnetic field, indicated by flux lines 46. The strength of the magnetic field depends on the supply of current through the coil. As coils 44 are energized, a magnetic field is generated, thereby affecting magnetic particles 34 and imparting a resistive braking torque on the shaft 20. By imparting resistive torque on the shaft, an operator has a tactile experience that simulates forces associated with controls for mechanically-driven heads.

Other types of brakes and braking systems may be incorporated into the haptic force-feedback control system. Brake types include, but are not limited to, piezoelectric brakes and piezo- or electromagnetically actuated disc or drum brakes. However, the braking forces imparted by such brakes are preferably capable of variable modulation in relative proportion to the supply of electric current.

Referring back to FIG. 3, a control system 10 such as a handwheel assembly 14 also includes a sensor system 18 coupled to the shaft 20. The sensor system 18 monitors motion of a control element 12 and/or other types of control elements (e.g. joysticks). The sensor system 18 includes at least one motion-sensing transducer 48 (FIG. 5), coupled to the handwheel assembly 14 and shaft 20. Suitable transducers include optical encoders, magnetic encoders, and absolute encoders.

To achieve desirable haptic effects, particularly at lower speeds, the sensor system 18 includes a motion-sensing transducer 48 having high resolution. Suitable transducers include those capable of monitoring about 40,000 counts/revolution to about 100,000 counts/revolution. However, depending on the control system, transducers capable of monitoring about 10,000 counts/revolution may be appropriate. High resolution transducers are preferred.

The sensor system may also include resolution control devices (not shown), which may be used to vary resolution of the motion-sensing transducer. For example, one or more timing belts and gears may be used to vary resolution of the motion-sensing transducer. These devices are coupled to the sensor system and may be positioned between the sensor system 18 and the control element 12.

The motion-sensing transducer may generate as output digital pulses, analog signals, or any other type of signal and/or data to represent the sensed motion. The output of the motion sensing transducer may be monitored by control circuitry 50, schematically shown in FIG. 5. Control circuitry 50 may be a microprocessor, digital signal processor, or other capable analog or digital control circuitry.

Referring to FIG. 5, control circuitry 50 is configured within firmware to perform an algorithm, which, on an input side, tracks data from the motion-sensing transducer and, on an output side, converts a signal to yield a power source 45 for the haptic element 26. Additionally, an amplifier 58 (not shown) may be coupled to the output of the control circuitry to power the haptic element.

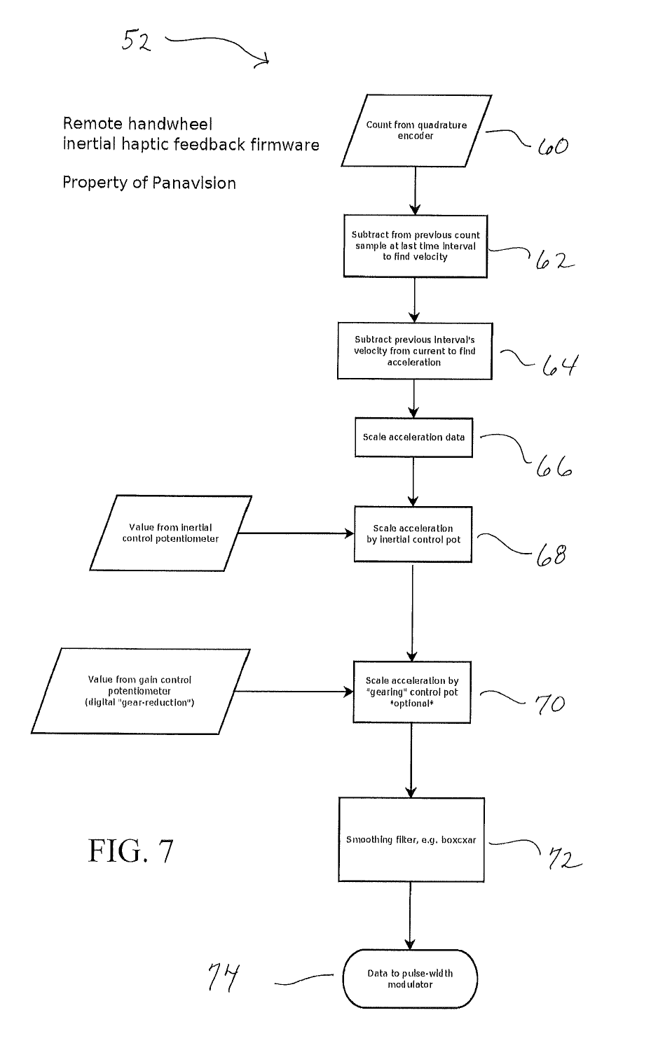

FIG. 7 shows the implementation of control circuitry 50, according to a process flow chart 52. The flow chart 52 outlines steps which are executed in regular intervals, using control circuitry 50. These intervals are preferably granular enough in time so that implementation is generally undetectable by an operator, using the control system. Interval frequency is preferably in the range of about 100 Hertz to about 500 Hertz.

The steps include:
(1) Inputting count data from the motion-sensing transducer 60 to yield a sample count;
(2) Calculating velocity data 62, using count data at the last time interval;
(3) Calculating acceleration data 64, using calculated velocity data;
(4a) A first scaling of acceleration data 66, using a hard-coded or hard-wired scale factor.
(4b) A second scaling of acceleration data 68, using values from a first input device 54;
(5) A third scaling of acceleration data 70, using values from a second input device 56;
(6) Optionally, performing one or more filtering steps 72, using a smoothing filter; and
(7) Amplifying and outputting data 74 for powering of the haptic element.

The control circuitry scales acceleration data greater than zero. In another optional configuration, the control circuitry may scale acceleration data less than zero, when using a motor instead of a brake. Use of the control circuitry in this optional configuration would result in a “true” inertial system having an accelerating effect on rotatable-type control elements coupled to the input device, e.g. when an operator is decelerating a handwheel.

Where the control circuitry scales acceleration data greater than zero, both the first input device 54 and the second input device 56 may be potentiometers, optical encoders, or other devices suitable for measuring inertial loads and simulating the effect of inertial loads in controls for mechanically-driven heads, particularly gear-driven heads. Where either the first or second input device is a potentiometer, it may be coupled to an operator driven device 57 capable of manual manipulation, such as a knob or slider. The operator driven device is used to increase or decrease the relative feel of the haptic effect (i.e. output gain) to the operator's preferred tactile experience. The second input device may similarly be a potentiometer coupled to a second operator driven device 59 capable of manual manipulation, such as a knob or slider. The second operator driven device can have an additional function of allowing the operator to adjust the number of revolutions that the head makes per the number of rotatable-type control element revolutions (e.g. handwheel revolutions) as the device scales the haptic effect.

Filtering steps 72 are executed by control circuitry 50 to smooth out acceleration jitters, which may cause distracting artifacts in haptic force-feedback effects. After filtering, outputting data 74 occurs, using an encoder, such as a pulse-width modulator (PMW), which yields a signal capable of being converted to a power source for the haptic element.

Using the control systems and haptic force-feedback systems described above, an operator can have a tactile experience associated with controls of motorized heads. For example, where the control element is a handwheel and the haptic element is a magnetic particle brake, an operator can sense resistive forces as he or she accelerates the handwheel. However, these resistive forces are similar to those associated with acceleration of inertial loads in mechanical heads. Such resistive forces would not be typically experienced in electrically-driven control elements used for remote heads. Using the sensor system described above, the aforementioned control systems and haptic force-feedback systems are configured to respond proportionally to handwheel acceleration.

Thus, control systems and haptic force-feedback systems that simulate forces associated with controls for mechanical heads are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A control system for a remote head, comprising:
a control element coupled to the remote head;
a haptic force-feedback system coupled to the control element that simulates forces associated with controls for a mechanical head; and
a sensor system configured to monitor motion of the control element.

2. The control system of claim 1, wherein the sensor system provides a power source for the at least one haptic element.

3. The control system of claim 1, wherein the control element comprises one of a handwheel, a joystick, a panbar, a lever, and a knob.

4. The control system of claim 1, further comprising control circuitry that commands the sensor system.

5. The control system of claim 1, wherein the control element is indirectly coupled to the remote head.

6. The control system of claim 1, wherein the haptic force-feedback system comprises a haptic element.

7. The control system of claim 5, wherein the haptic element comprises one of a brake, a motor, and a stiffness element.

8. The control system of claim 1, wherein the haptic force-feedback system is electrically powered.

9. A haptic force-feedback system for a remote head, comprising:
a haptic element coupled to the remote head and configured to simulate forces associated with controls coupled to a mechanical head; and
a sensor system coupled to a haptic element configured to monitor motion of a control element.

10. The haptic force-feedback system of claim 9, wherein the haptic element comprises one of a brake, a motor, and a stiffness element.

11. The haptic force-feedback system of claim 9, wherein at least one haptic element is electrically powered.

12. The haptic force-feedback system of claim 9, wherein the control element comprises a rotatable component.

13. The haptic force-feedback system of claim 9, wherein the control element comprises a translatable component.

14. The haptic force-feedback system of claim 9, the control element comprises one of a handwheel, a joystick, a panbar, a lever, and a knob.

15. The haptic force-feedback system of claim 9, wherein the sensor system provides a power source for the haptic element.
